(19) United States
(12) Patent Application Publication
(10) Pub. No.: US 2021/0383391 A1
(43) Pub. Date: Dec. 9, 2021

(54) SYSTEMS AND METHODS FOR FRAUD DISPUTE OF PENDING TRANSACTIONS

(71) Applicant: Fidelity Information Services, LLC, Jacksonville, FL (US)

(72) Inventors: Christopher J. Barry, Wake Forest, NC (US); Henrigue Bolivar, Tampa, FL (US); Drew Everman, Brandon, FL (US); Charles G. Lucas, Valrico, FL (US); Phyllistine McCrary, Birmingham, AL (US); Brandon Shepard, Milwaukee, WI (US); Manmeet Singh Gurjakhia, Milwaukee, WI (US)

(73) Assignee: Fidelity Information Services, LLC., Jacksonville, FL (US)

(21) Appl. No.: 16/892,026

(22) Filed: Jun. 3, 2020

(51) Int. Cl. G06Q 20/40; G06Q 30/00; G06Q 30/02; G06Q 20/08; G06Q 20/20; G06Q 20/42; G06Q 20/34; G06Q 40/02; H04L 29/06; G06N 3/08; H04L 29/08

(52) U.S. Cl. CPC G06Q 20/4016; G06Q 30/0185; G06Q 30/0203; G06Q 20/0855; G06Q 20/203; H04L 67/306; G06Q 20/34; G06Q 40/02; H04L 63/08; G06N 3/08; G06Q 20/42

(57) ABSTRACT

A system for fraud dispute of pending transactions. The system comprising receiving data corresponding to a pending transaction between the user and a merchant; and analyzing the transaction data to determine whether the transaction data comprises at least one indicator of a fraudulent transaction. Wherein, pausing an initiation to provide funds for the pending transaction, providing the user at least one questionnaire relating to the received transaction data or a set of stored user data, receiving a response from the user for the questionnaire, comparing the received response to the received transaction data or the stored user data, determining whether to validate the user based on the comparison, rejecting the pending transaction when the user is not validated, and removing the indicator when the user is validated. Wherein, approving the pending transaction, and initiating a request to provide funds to the merchant. And storing the received transaction data and analysis.

### TECHNICAL FIELD

The present disclosure generally relates to systems and methods for fraud dispute of pending transactions.

### BACKGROUND

Given increases in brick-and-mortar sales, as well as online sales, financial service providers (“FSPs”) utilize significant resources on sale transaction dispute processing. Current estimates suggest that U.S. financial institutions collectively (FSPs and banks) spend over $3 billion processing disputes, and for every $100 spent in sales, 7% are disputed. Part of those processing costs are due to monitoring high rates of fraud refund (e.g., fraudulent charges on customer accounts), and alternatively, due to protecting against refund fraud (e.g., customers or merchants fraudulently requesting refunds).

One processing problem FSPs face is the plethora of available input data, and FSPs lack abilities to properly apply the data for dispute resolution. Every dispute involves several parties, including at least the customer buying goods or services, and the merchant selling the goods or services, and often including a third party FSP processing the transaction. Proper dispute resolution typically requires data from each involved party, and often the available data goes unused. There is a need for a system that connects multiple streams of data from the multiple parties while remaining transparent to each of those parties.

While some solutions exist for resolving fraud dispute of pending transactions, such solutions typically stop there. These prior solutions fail to collect the necessary data, fail to provide the user with real time alerts for flagged potentially fraudulent transactions, fail to investigate further with the respective parties, and fail to analyze the transaction data. There is a need for a system that collects data and integrates fraud detection systems with data science algorithms as described herein.

The present disclosure provides systems, methods, and devices to solve these and other problems.

### SUMMARY

In the following description, certain aspects and embodiments of the present disclosure will become evident. It should be understood that the disclosure, in its broadest sense, could be practiced without having one or more features of these aspects and embodiments. Specifically, it should also be understood that these aspects and embodiments are merely exemplary. Moreover, although disclosed embodiments are discussed in the context of a processor, it is to be understood that the disclosed embodiments are not limited to any particular industry.

Disclosed embodiments include a system for fraud dispute of pending transactions comprising one or more memory devices storing instructions, and one or more processors configured to execute the instructions to perform operations. The operations comprising receiving data corresponding to a pending transaction between the user and a merchant; and analyzing the transaction data to determine whether the transaction data comprises at least one indicator of a fraudulent transaction. When the transaction data comprises at least one indicator, pausing an initiation to provide funds for the pending transaction, providing the user at least one questionnaire relating to the received transaction data or a set of stored user data, receiving a response from the user for the questionnaire, comparing the received response to the received transaction data or the stored user data, determining whether to validate the user based on the comparison, rejecting the pending transaction when the user is not validated, and removing the indicator when the user is validated. Wherein, when the transaction data does not comprise at least indicator, approving the pending transaction, and initiating a request to provide funds to the merchant. And, the operations further comprising storing the received transaction data, and the analysis.

It is to be understood that both the foregoing general description and the following detailed description are exemplary and explanatory only, and are not restrictive of the disclosed embodiments, as claimed.

### BRIEF DESCRIPTION OF DRAWINGS

The accompanying drawings, which are incorporated in and constitute a part of the specification, illustrate several embodiments and, together with the description, serve to explain the disclosed principles. In the drawings:

FIG. 1 is a block diagram of an exemplary system, consistent with disclosed embodiments.

FIG. 2 is a diagram of an exemplary electronic system, consistent with disclosed embodiments.

FIG. 3A is a diagram of an exemplary fraud dispute system consistent with disclosed embodiments.

FIG. 3B is a diagram of an exemplary fraud dispute system consistent with disclosed embodiments.

FIG. 3C is a diagram of an exemplary fraud dispute system consistent with disclosed embodiments.

FIG. 3D is a diagram of an exemplary fraud dispute system consistent with disclosed embodiments.

FIG. 3E is a diagram of an exemplary fraud dispute system consistent with disclosed embodiments.

FIG. 3F is a diagram of an exemplary fraud dispute system consistent with disclosed embodiments.

FIG. 3G is a diagram of an exemplary fraud dispute system consistent with disclosed embodiments.

FIG. 4A is a diagram of an exemplary fraud dispute system consistent with disclosed embodiments.

FIG. 4B is a diagram of an exemplary fraud dispute system consistent with disclosed embodiments.

FIG. 4C is a diagram of an exemplary fraud dispute system consistent with disclosed embodiments.

FIG. 4D is a diagram of an exemplary fraud dispute system consistent with disclosed embodiments.

FIG. 4E is a diagram of an exemplary fraud dispute system consistent with disclosed embodiments.

FIG. 4F is a diagram of an exemplary fraud dispute system consistent with disclosed embodiments.

FIG. 4G is a diagram of an exemplary fraud dispute system consistent with disclosed embodiments.

FIG. 4H is a diagram of an exemplary fraud dispute system consistent with disclosed embodiments.

FIG. 5 is a flowchart of an exemplary fraud dispute method.

FIG. 6 is a flowchart of an exemplary fraud dispute method.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence, nor constrained to a particular system configuration. Additionally, some of the described embodiments or elements thereof can occur or be performed simultaneously, at the same point in time, or concurrently.

An initial overview of data science algorithms (e.g., machine learning) is first provided immediately below and then specific exemplary embodiments of systems and methods for resolving fraud disputes of pending transactions follow in further detail. The initial overview is intended to aid in understanding some of the technology relevant to the systems and methods disclosed herein, but it is not intended to limit the scope of the claimed subject matter.

There are two subfields of data science algorithms—knowledge-based systems and machine learning systems. Knowledge-based approaches rely on the creation of a heuristic, or rule-base, which is then systematically applied to a particular problem or dataset. Knowledge-based systems make decisions based on an explicit “if-then” rule. Such systems rely on extracting a high degree of knowledge about a limited category in order to virtually render all possible solutions to a given problem. These solutions are then written as a series of instructions to be sequentially followed by a machine.

Machine learning, unlike the knowledge-based programming, provides machines with the ability to learn through data input without being explicitly programmed with rules. For example, as just discussed, conventional knowledge-based programming relies on manually writing algorithms (i.e. rules) and programming instructions to sequentially execute the algorithms. Machine learning systems, on the other hand, avoid following strict sequential programming instructions by making data-driven decisions to construct their own rules. The nature of machine learning is the iterative process of using rules, and creating new ones, to identify unknown relationships to better generalize and handle non-linear problems with incomplete input data sets.

Examples of machine learning techniques include, but are not limited to decision tree learning, association rule learning, inductive logic programming, anomaly detecting, support vector machining, clustering, density-based spatial clustering, Bayesian networking, reinforcement learning, representation learning, category modeling, similarity and metric learning, spare dictionary learning, rule-based machine learning, and artificial neural networking.

One such machine learning technique involves the use of artificial neural networks. Artificial neural networks are computational systems that enable computers to essentially function in a manner analogous to that of the human brain. Generally, a neural network is an information-processing network and an artificial neural network is an information-processing network inspired by biological neural systems. Artificial neural networks create non-linear connections between computation elements (i.e., “nodes” and “clusters”) operating in parallel and arranged in patterns. The nodes are connected via variable weights, typically adopted during use, to improve performance. Thus, in solving a problem or making a prediction, an artificial neural network model can explore many hypotheses and permutations by simultaneously using massively parallel networks composed of many computational elements connected by links with variable weights.

Another example of machine learning is supervised learning models for support-vector machines. Instead of the node computation elements typically associated with neural networks, vector machining comprises hyperplane constructs in high- or infinite-dimensional space to analyze data point clustering. Unlike a neural network “cluster” defined by its weighted association with other neural network clusters and nodes, vector machining analyzes how data points fall within the dimensional space and how the data points “cluster” together. The hyperplane construct utilizes outlier detection algorithm for classification and regression analysis of the data clustering.

As already discussed, these techniques are not programmed; instead, they are “taught.” Of course, there are many variations for teaching. Some techniques include teaching through examples, whereas others extract information directly from the input data. The two variations are called “supervised” and “unsupervised” learning. In supervised systems, rather than anticipating every possible outcome, supervised networks attempt to characterize data by recognizing patterns. The supervised system then makes decisions based on conformity of recognized patterns with historical patterns and known attributes. A learning algorithm adjusts algorithm (i.e. weighting) factors for optimal performance based predetermined sets of correct taught stimulus-response pairs. Training supervised networks is iterative and involves repeatedly adjusting weights until the system arrives at the correct output. After training, the resulting architecture of the taught supervised network embodies the algorithm.

On the other hand, unsupervised systems require no historical training data. An unsupervised network is autonomous and automatically determines data properties. Unsupervised networks factor in individual data producing events, as well as the event's relationship with other events and predetermined collective event characterizations.

Reference will now be made in detail to the disclosed embodiments, examples of which are illustrated in the accompanying drawings. Wherever convenient, the same reference numbers will be used throughout the drawings to refer to the same or like parts. Unless explicitly stated, sending and receiving as used herein are understood to have broad meanings, including sending or receiving in response to a specific request or without such a specific request. These terms thus cover both active forms, and passive forms, of sending and receiving.

The following description provides examples of systems and methods for fraud dispute of pending transactions. The arrangement of components shown in the figures is not intended to limit the disclosed embodiments, as the components used in the disclosed systems may vary.

As discussed above, some solutions exist for resolving fraud dispute of pending transactions, however, such solutions typically stop there. These prior solutions fail to collect the necessary data, fail to provide the user with real time alerts for flagged potentially fraudulent transactions, fail to investigate further with the respective parties, and fail to analyze the transaction data.

The following embodiments provide examples of incorporating fraud monitoring systems with data science algorithms in order to analyze vast sources of data. For instance, some embodiments below narrow the fraud dispute resolution analysis down to whether a customer account card was present during the transaction. Some embodiments analyze the interactions between customer and FSP, between merchant and FSP, and/or between customer and merchant by analyzing data from all the parties with machine learning algorithms. The machine learning algorithms may generate behavior scores to assist in weighting likelihoods of fraud (either dispute fraud or fraud dispute). Alternatively, in some embodiments, the machine learning algorithms may generate fraud resolution determinations and refund estimates.

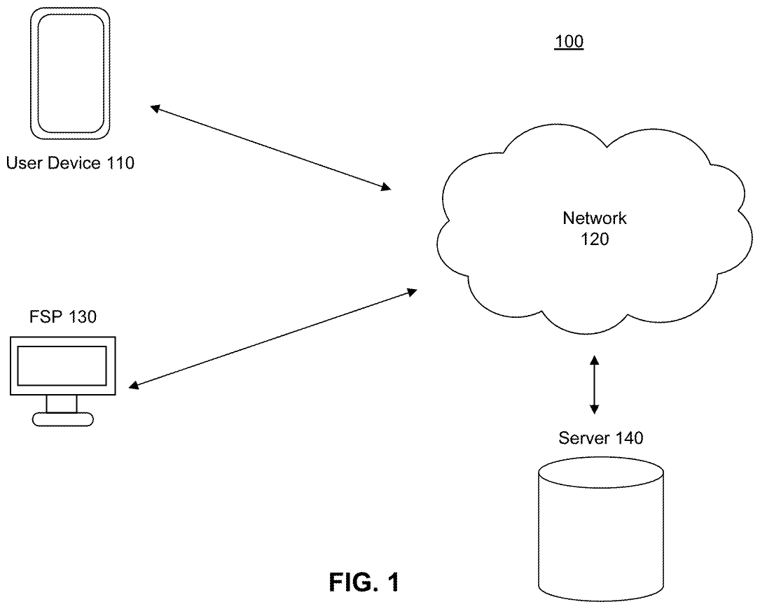

FIG. 1 is a block diagram illustrating an exemplary system 100 for fraud dispute of pending transactions. System 100 may be used by a customer to create or review a fraud dispute of a pending transaction. Alternatively, in some embodiments, system 100 may be used by a merchant to create a fraud dispute of a pending transaction, or to review a pending dispute. In some embodiments, system 100 may be used by a financial service provider to create, review, or confirm a pending fraud dispute. In some embodiments, an account card associated with a customer may have been present during the disputed transaction. Alternatively, in some embodiments, the account card associated with the customer may not have been present during the disputed transaction. System 100 may include a user device 110, a network 120, a financial service provider (“FSP”) 130, and a server 140. In some embodiments, as shown in FIG. 1, each component of system 100 may be connected to network 120. However, in other embodiments, components of system 100 may be connected directly with each other without network 120.

User device 110 may include one or more computing devices configured to perform operations consistent with disclosed embodiments. For example, user device 110 may include at least one of a desktop computer, a laptop, a server, a mobile device (e.g., tablet, smart phone, etc.), a gaming device, a wearable computing device, or other type of computing device. User device 110 may include one or more processors configured to execute software stored as instructions in memory. User device 110 may implement software to perform Internet-related communication and content display processes. For instance, user device 110 may execute browser software that generates and displays interfaces, including content, on a display device included in, or connected to, user device 110. User device 110 may execute applications that allow user device 110 to communicate with components over network 120, and generate and display content in interfaces via a display device included in user device 110. The disclosed embodiments are not limited to any particular configuration of user device 110. For instance, user device 110 can be a mobile device that stores and executes mobile applications that interact with network 120 and server 140 to perform aspects of the disclosed embodiments, such as creating and reviewing disputed pending transactions. In certain embodiments, user device 110 may be configured to execute software instructions relating to location services, such as GPS locations. For example, user device 110 may be configured to determine a geographic location (e.g., geo-location spatial reference coordinates) and provide location data and time stamp data corresponding to the location data. In yet other embodiments, user device 110 may capture video and/or images, or alternatively, user device 110 may play video and/or audio as well as display images. User device 110 may be associated with a customer attempting to purchase an item or service (e.g., a pending transaction), or alternatively, user device 110 may be associated with a merchant offering the item or service.

Network 120 may be any type of network configured to provide communications between components of system 100. For example, network 120 may be any type of network (including infrastructure) that provides communications, exchanges information, and/or facilitates the exchange of information, such as the Internet, a Local Area Network, near field communication (NFC), optical code scanner, or other suitable connection(s) that enables the sending and receiving of information between the components of system 100. In some embodiments, one or more components of system 100 can communicate through network 120. In various embodiments, one or more components of system 100 may communicate directly through one or more dedicated communication links.

FSP 130 may include one or more computing devices configured to perform operations consistent with disclosed embodiments. Like user device 110, FSP 130 may include at least one of a desktop computer, a laptop, a server, a mobile device (e.g., tablet, smart phone, etc.), a gaming device, a wearable computing device, or other type of computing device. FSP 130 may include one or more processors configured to execute software stored as instructions in memory. FSP 130 may implement software to perform Internet-related communication and content display processes. For instance, FSP 130 may execute browser software that generates and displays interfaces, including content, on a display device included in, or connected to, FSP 130. FSP 130 may execute applications that allow FSP 130 to communicate with components over network 120, and generate and display content in interfaces via a display device included in FSP 130. The disclosed embodiments are not limited to any particular configuration of FSP 130. For instance, FSP 130 can be a mobile device that stores and executes mobile applications that interact with network 120 and server 140 to perform aspects of the disclosed embodiments, such as creating and reviewing disputed pending transactions. In certain embodiments, FSP 130 may be configured to execute software instructions relating to location services, such as GPS locations. For example, FSP 130 may be configured to determine a geographic location and provide location data and time stamp data corresponding to the location data. In yet other embodiments, FSP 130 may capture video and/or images, or alternatively, FSP 130 may play video and/or audio as well as display images. FSP 130 may be further associated with user device 110, or alternatively, FSP 130 may be associated with a third-party entity such as a bank, a credit card company, an investment company, or any other entity which handles financial transactions for customers and/or merchants.

Server 140 may include one or more computing devices configured to provide data to one or more of user device 110, network 120, or FSP 130. In some aspects, such data may include user account data such as username, email, password, or other such registration information. Alternatively, in alternative embodiments, such data may include information for the fraud dispute such as an alert, or a pending transaction. Such data may include captured data such as images or videos of products and/or item stock keeping unit (“SKU”) codes, or alternatively, in some embodiments such data may include uploaded information from the user or a third-party source. Such data may also include user notes on particular products. Server 140 may include, for example, one or more Oracle™ databases, Sybase™ databases, or other relational databases or non-relational databases, such as Hadoop™ sequence files, HBase™, or Cassandra™. Server 140 and the database(s) may include computing components (e.g., database management system, database server, etc.) configured to receive and process requests for data stored in memory devices of the database(s) and to provide data from the database(s). While server 140 is shown separately, in some embodiments server 140 may be included in or otherwise related to one or more of user device 110, network 120, and/or FSP 130.

It is to be understood that the configuration and boundaries of the functional building blocks of system 100 have been defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

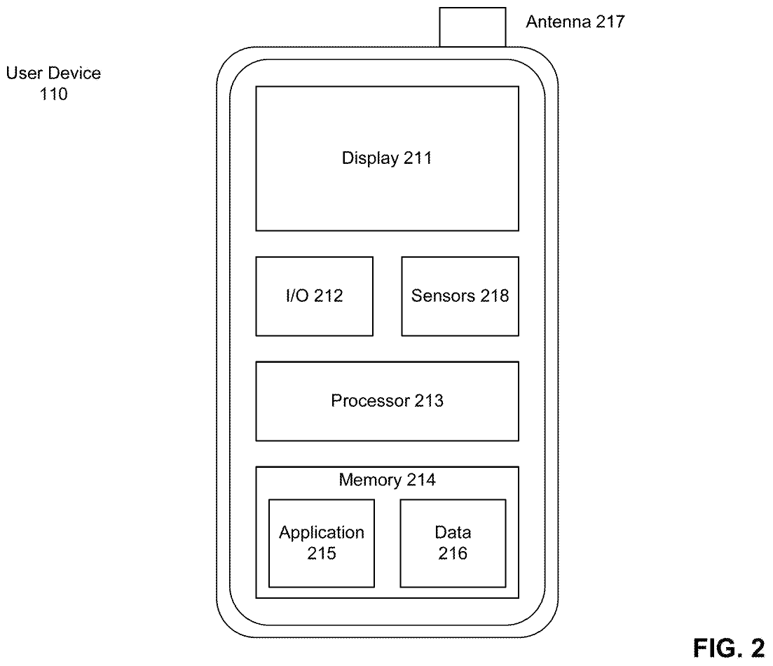

FIG. 2 illustrates an exemplary configuration of user device 110, consistent with disclosed embodiments. Variations of user device 110 may be used to implement portions or all of each of the devices of system 100. Likewise, even though FIG. 2 depicts user device 110, it is understood that devices associated with network 120, FSP 130, and server 140 may implement portions illustrated by exemplary user device 110. As shown, user device 110 may include a display 211, an input/output (“I/O”) device 212, one or more processors 213, and a memory 214 having stored therein one or more program applications 215, and data 216. User device 110 also may include an antenna 217 and one or more sensors 218. One or more of display 211, I/O devices 212, processor(s) 213, memory 214, antenna 217, or sensor(s) 218 may be connected to one or more of the other devices depicted in FIG. 2. Such connections may be accomplished using a bus or other interconnecting device(s).

I/O devices 212 may include one or more devices enabling user device 110 to receive input from a user, such as user 112, and provide feedback to the user. I/O devices 212 may include, for example, one or more buttons, switches, speakers, microphones, or touchscreen panels. Additionally, I/O devices 212 may include in some embodiments augmented reality sensors and/or augmented reality eyewear. In some embodiments, I/O devices 212 may be manipulated by user 112 to input information into user device 110.

Processor 213 may be one or more known processing devices, such as a microprocessor from the Pentium™ or Atom™ families manufactured by Intel™, the Turion™ family manufactured by AMD™, the Exynos™ family manufactured by Samsung™, or the Snapdragon™ family manufactured by Qualcomm™. Processor 213 may constitute a single core or multiple core processors that executes parallel processes simultaneously. For example, processor 213 may be a single core processor configured with virtual processing technologies. In certain embodiments, processor 213 may use logical processors to simultaneously execute and control multiple processes. Processor 213 may implement virtual machine technologies, or other known technologies to provide the ability to execute, control, run, manipulate, store, etc., multiple software processes, applications, programs, etc. In another embodiment, processor 213 may include a multiple-core processor arrangement (e.g., dual, quad core, etc.) configured to provide parallel processing functionalities to allow user device 110 to execute multiple processes simultaneously. One of ordinary skill in the art would understand that other types of processor arrangements could be implemented that provide for the capabilities disclosed herein.

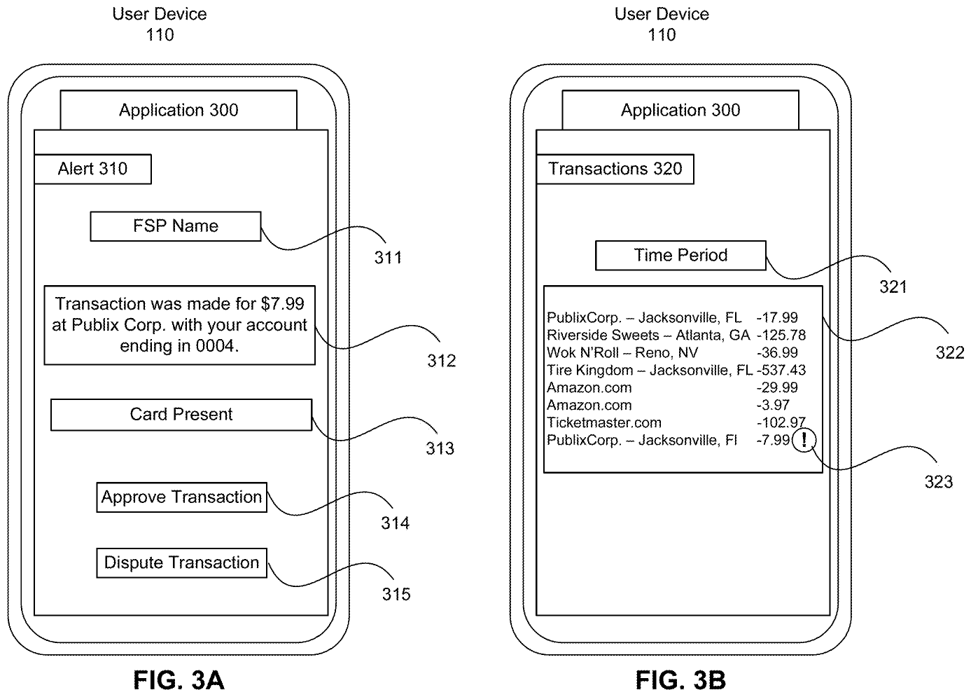

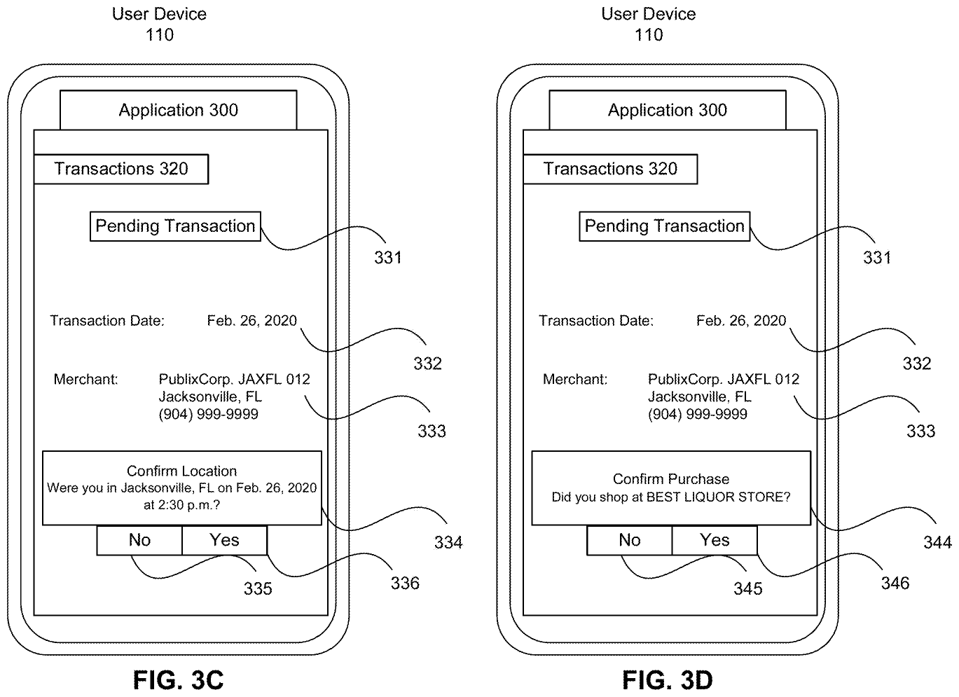

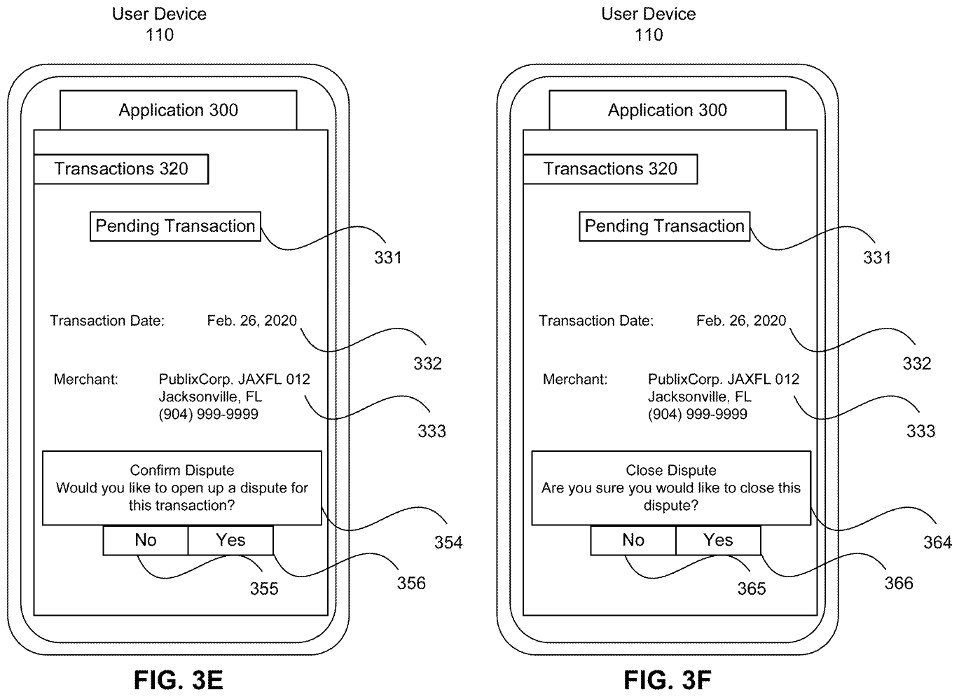

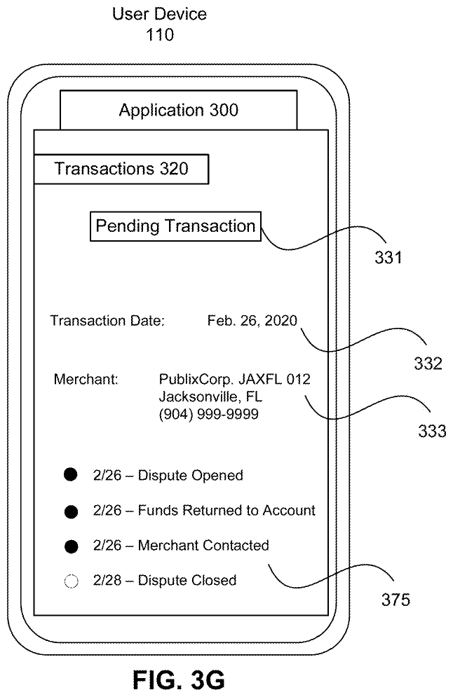

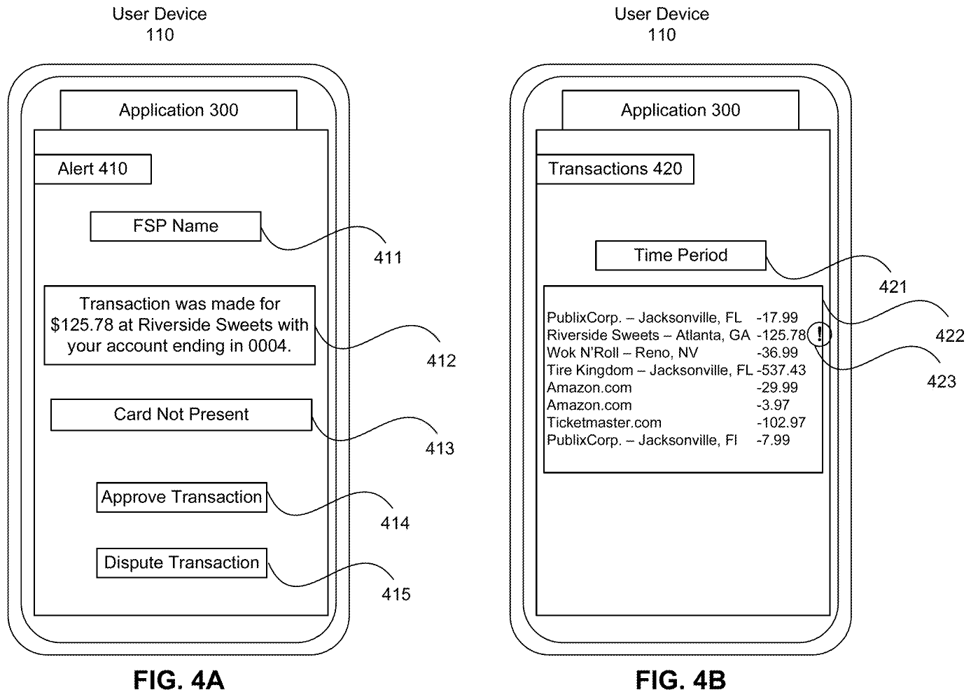

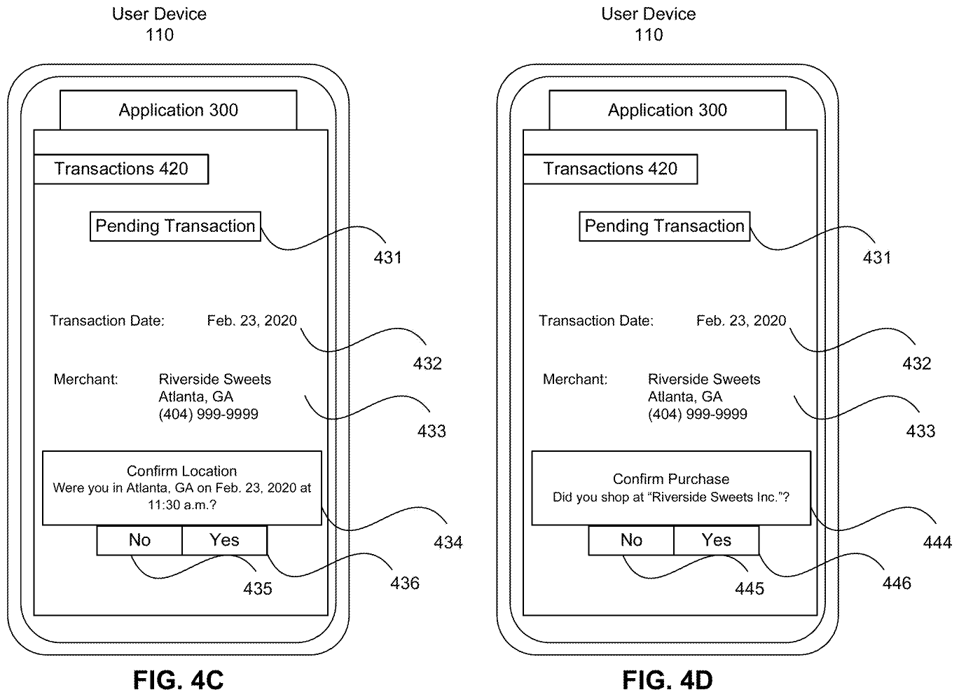

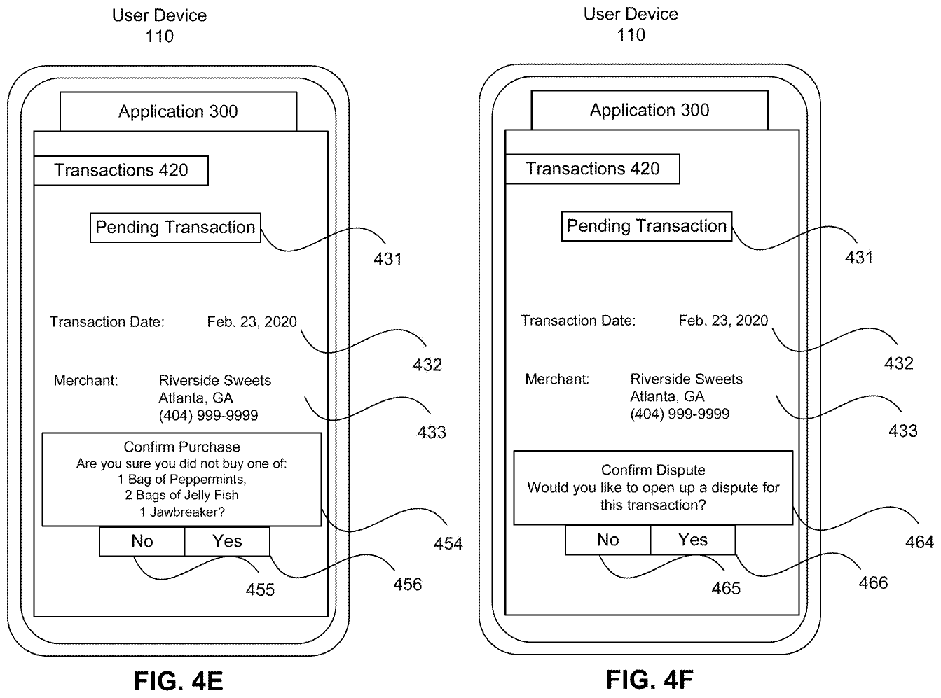

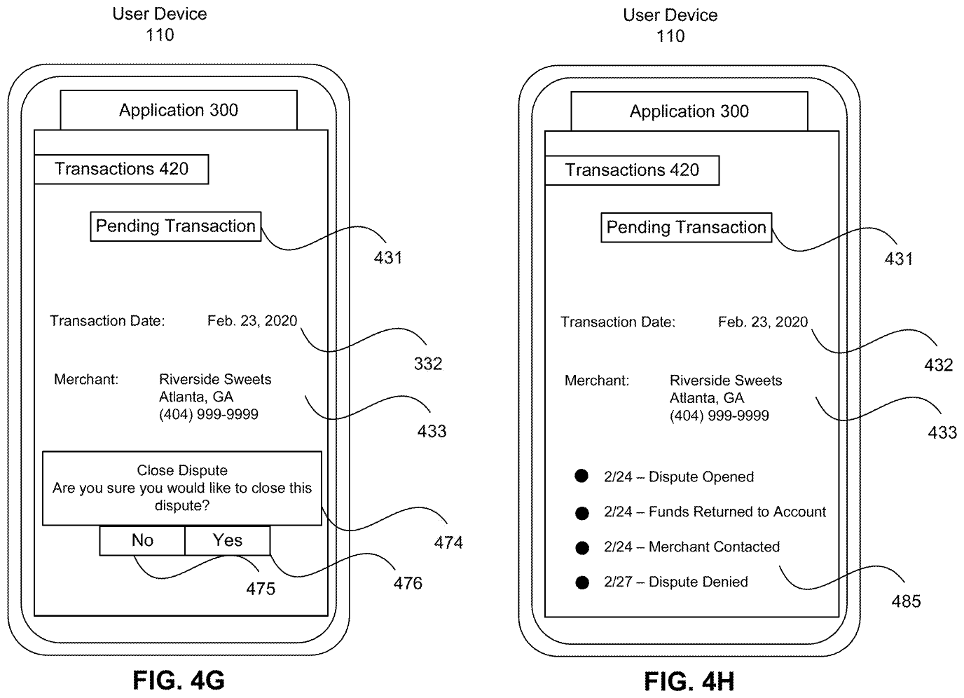

Memory 214 may be a volatile or non-volatile, magnetic, semiconductor, tape, optical, removable, non-removable, or other type of storage device or tangible (i.e., non-transitory) computer-readable medium that stores one or more program applications 215, and data 216. Program applications 215 may include, for example, a fraud dispute application configured to perform the operations and methods consistent with those described herein, and in particular FIGS. 3A-3G and 4A-4H.

Program applications 215 may also include operating systems (not shown) that perform known operating system functions when executed by one or more processors. By way of example, the operating systems may include Microsoft Windows™, Unix™, Linux™, Apple™, or Android™ operating systems, Personal Digital Assistant (PDA) type operating systems, such as Microsoft Windows CE™, or other types of operating systems. Accordingly, disclosed embodiments may operate and function with computer systems running any type of operating system. User device 110 may also include communication software that, when executed by processor 213, provides communications with network 120, such as Web browser software, tablet, or smart handheld device networking software, etc. User device 110 may be a device that executes mobile applications for performing operations consistent with disclosed embodiments, such as a tablet, mobile device, or smart wearable device.

Data 216 may include, for example, customer personal information, account information, and display settings and preferences. In some embodiments, account information may include items such as, for example, an alphanumeric account number, account label, account issuer identification, an ID number, and any other necessary information associated with a user and/or an account associated with a user, depending on the needs of the user, entities associated with network 120, and/or entities associated with system 100.

User device 110 may also store data 216 in memory 214 relevant to the examples described herein for system 100. One such example is the storage of user device 110 data such as time stamp and location proximity to a merchant associated with a pending transaction obtained from sensors 218. Data 216 may contain any data discussed above relating to the fraud dispute of pending transactions. For example, in some embodiments, data 216 may contain data relating to user device 110 location, IP addresses, account history, email history. Data 216 may contain data relating to third-party databases such as Worldpay Database, Featurespace, or State Commerce Sites (with consumer commerce data). In some embodiments, data 216 may contain item level data for pending transactions such as SKU codes or Standard Industrial Classification (SIC) codes. Alternatively, data 216 may contain user data such as identification data, account data, and log-in information, etc. Or, in some embodiments, data 216 may contain data from third party applications for gathering and processing consumer data such as Boku or Mint.

Antenna 217 may include one or more devices capable of communicating wirelessly. As per the discussion above, one such example is an antenna wirelessly communicating with network 120 via cellular data or Wi-Fi. Antenna 217 may further communicate with server 140 through any wired and wireless means.

Sensors 218 may include one or more devices capable of sensing the environment around user device 110 and/or movement of user device 110. In some embodiments, sensors 218 may include, for example, an accelerometer, a shock sensor, a gyroscope, a position sensor, a microphone, an ambient light sensor, a temperature sensor, and/or a conductivity sensor. In addition, sensors 218 may include devices for detecting location, such as, a Global Positioning System (GPS), a radio frequency triangulation system based on cellular or other such wireless communication and/or other means for determining user device 110 location.

In certain embodiments, user device 110 may include a power supply, such as a battery (not shown), configured to provide electrical power to user device 110.

FIGS. 3A-3G illustrate interfaces of an exemplary fraud dispute application 300. In some embodiments, application 300 may include the user interactive application 215 stored on user device 110, or alternatively, in other embodiments, application 300 may be stored in server 140. Application 300 may be an application interface applet for a web browser. Application 300 may comprise sub-menus such as alert 310, and transaction 320 described in FIGS. 3A-3G.

FIG. 3A illustrates an interface of an exemplary application 300 and sub-menu alert 310 for present account card transactions. In some embodiments, user device 110, FSP 130, and/or server 140 may determine that a pending transaction for a financial account associated with customer user is potentially fraudulent. If a pending transaction is potentially fraudulent, then application 300 may display alert 310 on user device 110. Alert 310 may further display an FSP name 311 associated with the pending transaction, with one or more of the respective merchant or customer for the pending transaction. Alert 310 may further display transaction details 312 for the pending transaction. Transaction details 312 may include transaction data such as the purchased item, the purchase price, the merchant, the purchase location, the purchase time, or customer financial account associated with the transaction and the account card. Alert 310 may further display an indicator 313 whether the account card was present or not during the transaction. Alert 310 may further prompt, with an interactive button, whether the user approves the transaction by selecting the approve button 314, or whether the user disputes the transaction by selecting the dispute button 315. Alternatively, in some embodiments, alert 310 may further display an additional interactive button prompting the user to progress to the transaction 320 sub-menu for additional details on the pending transaction. The user may opt to progress to transaction 320 sub-menu for additional details before selecting buttons 314 or 315.

FIG. 3B illustrates an interface of exemplary application 300 and sub-menu transaction 320 providing additional details on potentially fraudulent pending transactions. Transaction 320 may display details pertaining to the potentially fraudulent pending transaction based on user device 110 data or other such data stored in memory 214 and/or server 140. For instance, transaction 320 may display time data 321 pertaining to the approximate time period (e.g., day and time) the transaction occurred. Alternatively, in some embodiments, transaction 320 may display time data 321 for all pending transactions within a set time period (e.g., day and time) including potentially fraudulent and non-fraudulent transactions. In some embodiments, transaction 320 may display time data 321 for multiple fraudulent transactions based on their proximity to a user set time period (e.g., day and time).

Transaction 320 may also display financial transaction data 322. Financial transaction data 322 may comprise merchant level data. Although not displayed in FIG. 3B, financial transaction data 322 may comprise user rating level data for each respective merchant. The user level data may comprise fraudulent scores and/or overall scores on merchant quality. In some embodiments, financial transaction data 322 may comprise location level data if the transaction occurred at a physical brick-and-mortar merchant. In some embodiments, financial transaction data 322 may comprise purchase level data. The purchase level data may be for an entire purchase or it may be for item specific purchase prices. In some embodiments, financial transaction data 322 may comprise item level data such as SKU or SIC codes. It will be further understood by one skilled in the art that transaction 320 may further display interactive buttons, similar to buttons 314 and/or 315, associated with financial transaction data 322 wherein the user may approve or dispute specific transactions. Transaction 320 may also display warning indicator 323 flagging the potentially fraudulent transaction(s).

FIG. 3C illustrates an interface of exemplary application 300 and sub-menu transaction 320 providing additional details on selected potentially fraudulent pending transactions for the user to confirm. User may proceed with the system 100 flagged potentially fraudulent transaction, for instance in some embodiments, user may select button 315 to dispute the transaction, or alternatively, user may proceed with transactions identified as discussed above for FIG. 3B. Transaction 320 may display pending transaction data 331 based on data previously displayed in 322, and discussed in FIG. 3B, or alternatively in some embodiments, transaction data 331 may display a summary of the pending transaction. Transaction 320 may further display transaction date 332. Transaction date 332 may be based on the date of the pending transaction or based on the date of processing of the pending transaction. Transaction 320 may display merchant data 333 comprising the name of the merchant and its contact information. Based on the transaction data, transaction 320 may further request that the user confirm their presence at the merchant location and at the time of the purchase. Transaction 320 may display the respective transaction data for the confirmation prompt 334 such as the aforementioned merchant location and purchase time. Transaction 320 may further provide interactive buttons 335 and 336 enabling the user to deny their presence or confirm their presence at the merchant.

FIG. 3D, like FIG. 3C, illustrates an interface of exemplary application 300 and sub-menu transaction 320 providing additional details for the user to confirm. Transaction 320 displays similar data 331, 332, and 333 as described in FIG. 3C. Transaction 320 further displays user confirmation prompt 344 comprising merchant data. For instance, in some embodiments, user confirmation prompt 344 may request that the user confirm whether they shopped at a specific merchant (e.g. Best Liquor Store). Transaction 320 may further provide interactive buttons 345 and 346 enabling the user to deny shopping at the specific merchant or confirm.

It will be further understood by one skilled in the art that user confirmation prompts 334 and 344 are not limited to the data shown in FIGS. 3C and 3D. Application 300 may prompt user confirmation on any level of data (e.g. item, location, merchant, user, etc.). Alternatively, in some embodiments, application 300 may provide several progressing prompts for related levels of data (e.g. several item level prompts).

FIG. 3E illustrates an interface of exemplary application 300 and sub-menu transaction 320 prompting the user to confirm the fraudulent pending transaction dispute. As described in FIG. 3C, transaction 320 may display transaction data 331, 332, and 333. Transaction 320 may further display user confirmation prompt 354 for the user to confirm opening a dispute claim for the pending transaction. Transaction 320 may further provide interactive buttons 355 and 356 enabling the user to deny opening a dispute claim or confirming.

FIG. 3F illustrates an interface of exemplary application 300 and sub-menu transaction 320 prompting the user to confirm closing the dispute. It will be further understood by one skilled in the art that the user may close the opened dispute claim, as discussed in FIG. 3E, or alternatively, clearing the system 100 generated flagged dispute. As described in FIG. 3C, transaction 320 may display transaction data 331, 332, and 333. Transaction 320 may further display user confirmation prompt 364 for the user to confirm closing a dispute. Transaction 320 may further provide interactive buttons 365 and 366 enabling the user to deny closing the dispute claim or confirming.

FIG. 3G illustrates an interface of exemplary application 300 and sub-menu transaction 320 displaying dispute claim data. As described in FIG. 3C, transaction 320 may display transaction data 331, 332, and 333. Transaction 320 may further display dispute claim data 375 comprising the progress of the dispute claim. For instance, in some embodiments, dispute claim data 375 may comprise a timeline indicating when the dispute was opened (as discussed in FIG. 3E), when the funds were returned to the user account, when the merchant was contacted, and when the dispute was closed (as discussed in FIG. 3F).

FIGS. 4A-4H illustrate interfaces of an exemplary fraud dispute application 400. In some embodiments, application 400 may include the user interactive application 215 stored on user device 110, or alternatively, in other embodiments, application 400 may be stored in server 140. Application 400 may be an application interface applet for a web browser. Application 400 may comprise of sub-menus such as alert 410, and transaction 420 described in FIGS. 4A-4H.

FIG. 4A illustrates an interface of an exemplary application 400 and sub-menu alert 410 for non-present account card transactions (e.g. online purchases, etc.). In some embodiments, user device 110, FSP 130, and/or server 140 may determine that a pending transaction for a financial account associated with customer user is potentially fraudulent. If a pending transaction is potentially fraudulent, then application 400 may display alert 410 on user device 110. Alert 410 may further display an FSP name 411 associated with the pending transaction, and with either the respective merchant or customer for the pending transaction. Alert 410 may further display transaction details 412 for the pending transaction. Transaction details 412 may include transaction data such as the purchased item, the purchase price, the merchant, the purchase location, the purchase time, or customer financial account associated with the transaction and the account card. Alert 410 may further display an indicator 413 whether the account card was present or not during the transaction. Alert 410 may further prompt, with an interactive button, whether the user approves the transaction by selecting the approve button 414, or whether the user disputes the transaction by selecting the dispute button 415. Alternatively, in some embodiments, alert 410 may further display an additional interactive button prompting the user to progress to the transaction 420 sub-menu for additional details on the pending transaction. The user may opt to progress to transaction 420 sub-menu for additional details before selecting buttons 414 or 415.

FIG. 4B illustrates an interface of exemplary application 400 and sub-menu transaction 420 providing additional details on potentially fraudulent pending transactions. Transaction 420 may display details pertaining to the potentially fraudulent pending transaction based on user device 110 data or other such data stored in memory 214 and/or server 140. For instance, transaction 420 may display time data 421 pertaining to the approximate time period (e.g., day and time) the transaction occurred. Alternatively, in some embodiments, transaction 420 may display time data 421 for all pending transactions within a set time period (e.g., day and time) including potentially fraudulent and non-fraudulent transactions. In some embodiments, transaction 420 may display time data 421 for multiple fraudulent transactions based on their proximity to a user set time period (e.g., day and time).

Transaction 420 may also display financial transaction data 422. Financial transaction data 422 may comprise merchant level data. Although not displayed in FIG. 4B, financial transaction data 422 may comprise user rating level data for each respective merchant. The user level data may comprise fraudulent scores and/or overall scores on merchant quality. In some embodiments, financial transaction data 422 may comprise location level data if the transaction occurred at a physical brick-and-mortar merchant. In some embodiments, financial transaction data 422 may comprise purchase level data. The purchase level data may be for an entire purchase or it may be for item specific purchase prices. In some embodiments, financial transaction data 422 may comprise item level data such as SKU or SIC codes. It will be further understood by one skilled in the art that transaction 420 may further display interactive buttons, similar to buttons 414 and/or 415, associated with financial transaction data 422 wherein the user may approve or dispute specific transactions. Transaction 420 may also display warning indicator 423 flagging the potentially fraudulent transaction(s).

FIG. 4C illustrates an interface of exemplary application 400 and sub-menu transaction 420 providing additional details on selected potentially fraudulent pending transactions for the user to confirm. User may proceed with the system 100 flagged potentially fraudulent transaction, for instance in some embodiments, user may select button 415 to dispute the transaction, or alternatively, user may proceed with transactions identified as discussed above for FIG. 4B. Transaction 420 may display pending transaction data 431 based on data previously displayed in 422, and discussed in FIG. 3B, or alternatively in some embodiments, transaction data 431 may display a summary of the pending transaction. Transaction 420 may further display transaction date 432. Transaction date 432 may be based on the date of the pending transaction or based on the date of processing of the pending transaction. Transaction 420 may display merchant data 433 comprising the name of the merchant and its contact information. Based on the transaction data, transaction 420 may further request that the user confirm their presence at the merchant location and at the time of the purchase. Transaction 420 may display the respective transaction data for the confirmation prompt 434 such as the aforementioned merchant location and purchase time. Transaction 420 may further provide interactive buttons 435 and 436 enabling the user to deny their presence or confirm their presence at the merchant.

FIG. 4D, like FIG. 4C, illustrates an interface of exemplary application 400 and sub-menu transaction 420 providing additional details for the user to confirm. Transaction 420 displays similar data 431, 432, and 433 as described in FIG. 4C. Transaction 420 further displays user confirmation prompt 444 comprising merchant data. For instance, in some embodiments, user confirmation prompt 444 may request that the user confirm whether they shopped at a specific merchant (e.g. Riverside Sweets Inc.). Transaction 420 may further provide interactive buttons 445 and 446 enabling the user to deny shopping at the specific merchant or confirm.

It will be further understood by one skilled in the art that user confirmation prompts 434 and 444 are not limited to the data shown in FIGS. 4C and 4D. Application 400 may prompt user confirmation on any level of data (e.g. item, location, merchant, user, etc.). Alternatively, in some embodiments, application 400 may provide several progressing prompts for related levels of data (e.g. several item level prompts). For instance, FIG. 4E illustrates similar exemplary application 400 with sub-menu transaction 420, and like user confirmation prompt 444, FIG. 4E may display user confirmation prompt 454 requesting additional user confirmation of item level data. The user, via interactive buttons 455 and 466, may deny or confirm.

FIG. 4F illustrates an interface of exemplary application 400 and sub-menu transaction 420 prompting the user to confirm the fraudulent pending transaction dispute. As described in FIG. 4C, transaction 420 may display transaction data 431, 432, and 433. Transaction 420 may further display user confirmation prompt 464 for the user to confirm opening a dispute claim for the pending transaction. Transaction 420 may further provide interactive buttons 465 and 466 enabling the user to deny opening a dispute claim or confirming.

FIG. 4G illustrates an interface of exemplary application 400 and sub-menu transaction 420 prompting the user to confirm closing the dispute. It will be further understood by one skilled in the art that the user may close the opened dispute claim, as discussed in FIG. 4F, or alternatively, clearing the system 100 generated flagged dispute. As described in FIG. 4C, transaction 420 may display transaction data 431, 432, and 433. Transaction 420 may further display user confirmation prompt 474 for the user to confirm closing a dispute. Transaction 420 may further provide interactive buttons 475 and 476 enabling the user to deny closing the dispute claim or confirming.

FIG. 4H illustrates an interface of exemplary application 400 and sub-menu transaction 420 displaying dispute claim data. As described in FIG. 4C, transaction 420 may display transaction data 431, 432, and 433. Transaction 420 may further display dispute claim data 485 comprising the progress of the dispute claim. For instance, in some embodiments, dispute claim data 485 may comprise a timeline indicating when the dispute was opened (as discussed in FIG. 3F), when the funds were returned to the user account, when the merchant was contacted, and when the dispute was closed (as discussed in FIG. 3G).

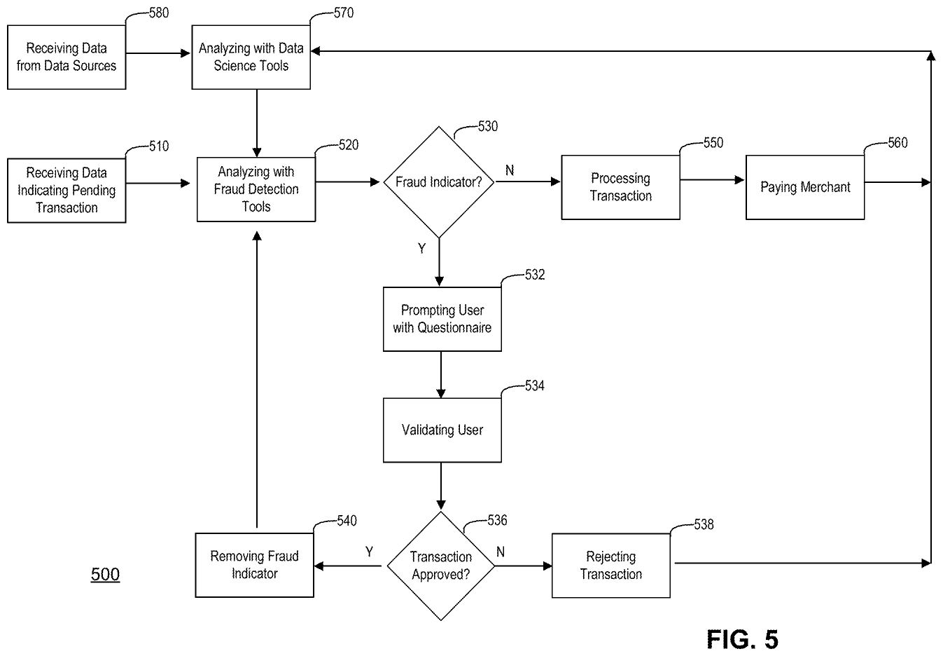

FIG. 5 is a flow chart of an exemplary method for resolving a fraud dispute for a pending transaction. As described herein, the dispute may be for transactions wherein the customer account card was present or was not present. It will be further understood by one skilled in the art that method 500 may be performed by a processing device such as user device 110 and processor 213, or alternatively, by FSP 130 or server 140. Method 500 begins at step 510 by receiving data indicating a pending transaction between a customer and merchant for the sale of an item or service. The received data may comprise merchant level, user level, item level, and/or transaction level data as discussed herein. The transaction data may be received from an FSP, from the merchant, or from the customer. The data may be received from an applet and graphical user interface (“GUI”) connected directly with the customer or merchant or routed through a third party. For instance, in some instances, the data may be received from an FSP processing the customer-merchant transaction; or alternatively, the data may be received from a support call center processing a customer inquiry. The received data comprises at least an indication of a pending transaction of a specific amount at a time between a customer and a merchant.

At step 520, method 500 analyzes the step 510 received data with fraud detection tools to determine whether the transaction is uncharacteristic for either the customer or the merchant. In some embodiments, the fraud detection tools may analyze party behaviors such as customer purchase history patterns (e.g., whether the customer pays with an account card present or not, whether the customer shops at the same merchant, etc.). Fraud detection tools may analyze purchase history patterns for customer, for merchant, or for customer at the specific merchant. In some embodiments, fraud detection tools may analyze previous problematic transactions, fraudulent transactions, or disputed transactions for customer. In some embodiments, fraud detection tools may analyze whether the pending transaction is duplicative or reoccurring.

In some embodiments, fraud detection tools may analyze device data. For instance, in some embodiments, fraud detection tools may analyze device identity data such as IP addresses, device model number, operating software version, etc., or geographical location data. In some embodiments, fraud detection tools may analyze customer or merchant account history. Fraud detection tools may analyze customer/merchant emails for electronic transactions.

Alternatively, in some embodiments, fraud detection tools may perform data hygiene on the received data from step 510. For instance, the fraud detection tools may not initially recognize the associated merchant because the merchant uses a misnomer or uses an intermediary for processing their transactions; or alternatively, the transaction may be split into several listings. Fraud detection tools may compare the received transaction from step 510 (or as discussed below from step 570) and compare it with state and national databases for merchant identities. Fraud detection tools may recognize connected merchants' identities, and/or connected repeated transaction listings. In some embodiments, fraud detection tools may revise or modify the received transaction data from step 510 (or from step 570) with appropriate merchant identities.

Fraud detection tools may assign a score to the customer, the merchant, and/or both. The score may be based on how trustworthy the party is. For instance, the score may be based on whether the party has a history of frivolous disputes, etc., or if the party has a history of targeted fraud attacks. Alternatively, in some embodiments, the score may be based on how accurate and reliable the data is from devices associated with the party. For instance, the party may be associated with a device with an operating system that provides inconsistent or inaccurate data. In some embodiments, fraud detection tools may base the score on data from third party reporting organizations or government agencies.

Fraud detection tools may utilize machine learning algorithms as discussed herein for analyzing the above functionality. For instance, in some embodiments, fraud detection tools may comprise support vector machine learning, density-based scanning, or anomaly detecting, etc. techniques for determining whether the pending transaction is uncharacteristic for either the merchant or the customer. Alternatively, in some embodiments, fraud detection tools may utilize neural networks for processing the data and assigning customer and merchant scores.

Based on the behavior analysis, device analysis, data hygiene, assigned score, and/or machine learning algorithms, fraud detection tools may flag the transaction for potential fraud by adding a fraud indicator to the pending transaction. Alternatively, in some embodiments, the received transaction data from step 510 may comprise a fraud indicator. For example, the customer may initiate step 510 with user device 110 and prompting a fraud dispute by including a fraud indicator with the transaction data.

At step 530, method 500 then determines whether the pending transaction contains a fraud indicator. As previously addressed, the pending transaction may receive a fraud indicator from the received transaction data , or alternatively, the fraud detection tools may add a fraud indicator to the pending transaction. For instance, in the event the customer account card was present, processing devices (e.g., user device 110 and processor(s) 213, FSP 130, or server 140) associated with method 500 may receive a notice from the customer that a pending charge is potentially fraudulent by updating applet associated with the transaction, or by inquiring about the transaction through a call center. The processing devices may add a fraud indicator in such event. Alternatively, as described above, fraud detection tools may add a fraud indicator to the pending transaction.

If the pending transaction contains a fraud indicator then method 500 proceeds to step 532 by prompting user with questionnaire(s). Questionnaire(s) may be provided to the customer and/or the merchant. And several questionnaire(s) may be provided based on customer and merchant responses. Like FIGS. 3C-3D and 4C-4E, questionnaire(s) prompt confirmation on any level of data (e.g. item, location, merchant, user, transaction, etc.). Alternatively, in some embodiments, questionnaire(s) may comprise several progressing questionnaire(s) for related levels of data. For instance, the customer may be initially prompted to confirm purchasing items from merchant, then a second questionnaire may request customer confirm purchase of specific items. The progressive nature of exemplary questionnaires enables determining the accuracy of the customer data, the authenticity of customer, and which specific item data is disputed. Alternatively, user may be prompted with a series of questionnaire(s) designed to confirm and/or clarify inaccuracies in the data. For example, geographical location data from user device 110 provided to fraud detection tools may suggest that the customer was at certain coordinates at a specific time, however, the customer questionnaire(s) responses may suggest they were not at that specific location at that time. Thus, user may receive additional questionnaire(s) based on customer and merchant responses.

In some embodiments, it may be determined that the user responses to questionnaire(s) are supported by received data, from either step 510 or step 570 (discussed below), and the pending transaction data may be updated with a user validation indicator at step 534. For instance, customer responses may be supported by merchant responses (e.g., both parties indicate that neither of their records suggest customer was at the merchant at the given time to purchase the items), or alternatively, customer responses may be supported by user device 110 data (e.g., mobile device geographical data suggests user was not within a certain radius of the purchase location). In such events, method 500 may validate the user based on the received data and received questionnaire responses.

At step 536, method 500 may determine whether to approve the transaction. Method 500 may implement a software application to make this determination, such as application 215. If the pending transaction has a fraud indicator and a user validation indicator, then the application may mark the transaction for rejection at step 538 and the pending transaction will be processed for rejection.. Otherwise, if the pending transaction has a fraud indicator and does not have a user validation indicator, then the application may mark the transaction for approval and remove the fraud indicator at step 540. Method 500 may reanalyze the pending transaction data with fraud detection tools again in view of the received questionnaire(s) responses by repeating steps 520 through 536.

When the pending transaction no longer has a fraud indicator, then the pending transaction may be processed at step 550. The transaction processing may comprise notifying an associated FSP of the transaction for approval. Alternatively, in some embodiments, the transaction processing may move the pending transaction from a fraud analysis procedure and back into a normal transaction routine.

At step 560, method 500 initiates paying the merchant based on the processed transaction. One skilled in the art will recognize that method 500 may initiate and process merchant payment, or alternatively, method 500 may notify an FSP that the transaction is approved and the FSP may initiate merchant payment.

In some embodiments, at step 570 method 500 may analyze the components of the transaction with data science tools. Like fraud detection tools, data science tools may receive behavior data, device data, data scores, and/or machine learning analysis from step 510 or step 580 (discussed below). Additionally, data science tools may receive data from fraud detection tools such as transaction data from step 538, and/or merchant payment data from step 560. And, like fraud detection tools, data science tools may implement machine learning as discussed herein. For instance, data science tools may implement the same machine learning algorithms as fraud detection tools, or different machine learning algorithms. In some embodiments, data science tools may analyze data sources and characterize the flow of data, whereas fraud detection tools may use that data and analysis for detecting fraud. Data science tools and fraud detection tools may be implemented as separate software objects or the same. Alternatively, data science tools and fraud detection may be implemented as artificial intelligence applets (e.g., artificial agent applets) that interact with the customer and merchant.

Data science tools may analyze party level data for the customer, the merchant, or both. In some embodiments, data science tools may analyze associated account histories or electronic email histories. In some embodiments, data science tools may analyze electronic invoices or analyze electronic images of receipts with optical character recognition (“OCR”). Alternatively, in some embodiments, data science tools may analyze third party consumer commerce data from state commerce sites such as SIC codes or fraud reporting systems. In some embodiments, data science tools may validate the party level data with third parties, may cross reference the received party data with additional data sources, and/or may weigh the party level data based on determined significance.

In some embodiments, data science tools may analyze device data. For instance, in some embodiments, data science tools may analyze device identity data such as IP addresses, device model number, operating software version, etc., or geographical location data. In some embodiments, data science tools may validate the device level data with third parties, may cross reference the received device data with additional data sources, and/or may weigh the device level data based on determined significance.

In some embodiments, data science tools may analyze item data. For instance, data science tools may analyze itemized SKU level data for pending transactions. Data science tools may analyze granular details about the items such as purchase price, rebates, sale events, average price, new price, used price, etc.

Alternatively, in some embodiments, data science tools 570 may perform data hygiene on the received data. For instance, it may not be readily apparent from the pending transaction data what the associated merchant is because the merchant uses a misnomer or uses an intermediary for processing their transactions; or alternatively, the transaction may be split into several listings. Data science tools may compare received data and compare it with state and national databases for merchant identities. Data science tools may recognize connected merchants' identities, and/or connected repeated transaction listings. In some embodiments, data science tools may revise or modify received data appropriate merchant identities.

At step 580, method 500 may further comprises receiving data from multiple data sources. Data sources may comprise data from user device 110 associated with the customer, or alternatively, user device 110 associated with the merchant. In some embodiments, data sources may comprise data from network 120 such as IP addresses or communication paths.

In some embodiments, data sources may comprise data from FSP 130 or from server 140. In some embodiments, data sources may exclusively include FSP 130, and/or server 140 thereby by passing the merchant. Data sources may include party level data, transaction level data, item level data as discussed herein such as geographical location data, IP addresses, account histories, databases (Worldpay or State Commerce databases), email records, Boku, or code connect APIs.

It will be understood by one skilled in the art that method 500 may comprise means for receiving various forms of data in various formats.

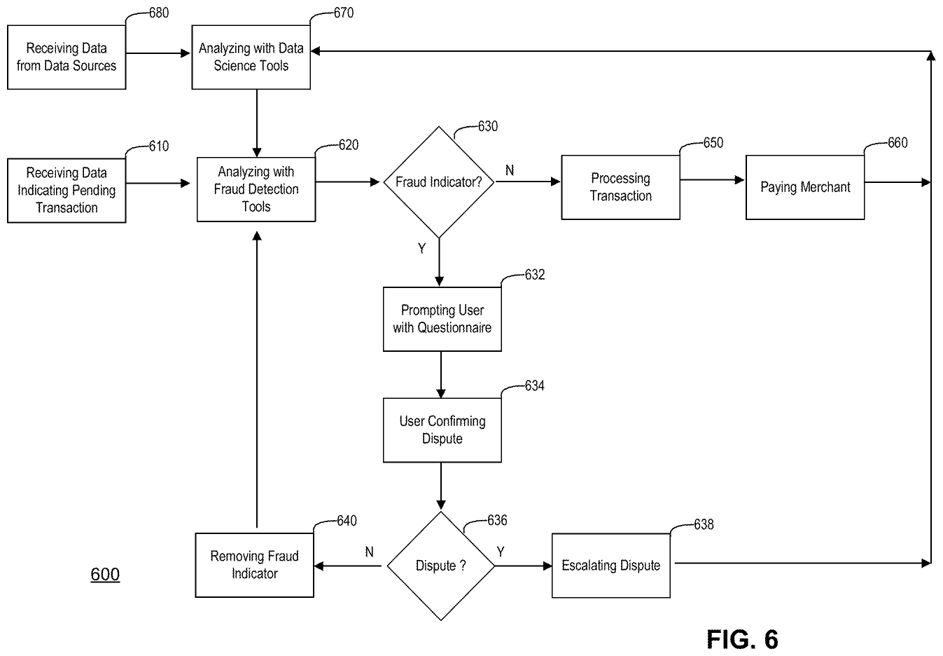

FIG. 6 is a flow chart of an exemplary method for resolving a fraud dispute for a pending transaction. As described herein, the dispute may be for transactions wherein the customer account card was present or was not present. Method 600 describes an exemplary process much like method 500, wherein method 600 incorporates an alternative step 634 for the user to confirm a dispute with the transaction. In some embodiments, the user may be a customer that wishes to escalate the fraud dispute process (e.g., user selecting button 356 from FIG. 3E) despite discrepancies from step 632 questionnaire(s). Alternatively, in some embodiments, the user may be a merchant that wishes to dispute customer questionnaire(s) responses or discrepancies. In such event, if user affirmatively confirms a dispute at step 634, then method 600 proceeds from step 636 to marking the pending transaction for dispute escalation and resolution at step 638. Transactions marked at step 638 for escalated dispute resolution may be further processed by processors associated with method 600 , or with processors associated with third party devices such as FSP 130 or server 140. Otherwise, method 600 proceeds from step 636 to step 640 if the user did not confirm a dispute at step 634 by removing the fraud indicator like method 500.

A person of ordinary skill will now understand that through these steps, system 100 further facilitates the goal processing fraud disputes for pending transactions. By utilizing numerous sources of data, system 100 may further assist the user by providing analytics and real time information pertaining to potentially fraudulent transactions.

While illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The elements in the claims are to be interpreted broadly based on the language employed in the claims and not limited to examples described in the present specification or during the prosecution of the application, which examples are to be construed as non-exclusive. It is intended, therefore, that the specification and examples be considered as exemplary only, with a true scope and spirit being indicated by the following claims and their full scope of equivalents.

What is claimed is:

1. A system for fraud dispute of pending transactions, comprising:
one or more memory devices storing instructions; and
one or more processors configured to execute the instructions to perform operations comprising:
receiving data corresponding to a pending transaction between the user and a merchant;
analyzing the transaction data to determine whether the transaction data comprises at least one indicator of a fraudulent transaction, wherein;
when the transaction data comprises at least one indicator:
pausing an initiation to provide funds for the pending transaction;
providing the user at least one questionnaire relating to the received transaction data or a set of stored user data,
receiving a response from the user for the questionnaire,
comparing the received response to the received transaction data or the stored user data,
determining whether to validate the user based on the comparison,
rejecting the pending transaction when the user is not validated, and
removing the indicator when the user is validated;
when the transaction data does not comprise at least one indicator:
approving the pending transaction, and initiating a request to provide funds to the merchant; and
storing the received transaction data, and the analysis.

2. The system of claim 1, wherein the received transaction data further comprises stock-keeping unit (SKU) data for a subset of items associated with the pending transaction.

3. The system of claim 1, wherein the stored user data comprises at least of a subset of user device data, a subset of user account data, and a subset of consumer commerce data.

4. The system of claim 3, wherein the subset of user device data further comprises geo-reference data, IP address data, or e-mail communication data.

5. The system of claim 4, wherein analyzing the transaction data further includes analyzing the received transaction data and the stored user data with an intelligent agent applet.

6. The system of claim 5, wherein the one or more processors are further configured to perform the operations comprising:
determining with the intelligent agent applet, and based on the stored user data, whether the pending transaction is further associated with a user account card physically present during the transaction;
notifying the user of the determination whether the user account card was physically present during the transaction; and
prompting the user to confirm the pending transaction.

7. The system of claim 1, wherein the one or more processors are further configured to analyze the stored user data, the stored received transaction data, and the stored analysis with a data tool.

8. The system of claim 7, wherein analyzing the transaction data further includes analyzing the received transaction data and the stored user data with the data tool to determine a user score.

9. The system of claim 8, wherein the data tool is a machine learning program comprising at least one of a data science algorithm application, a neutral network application, a density-based scan application, an anomaly detection application, a clustering system application, and a category modeling application.

10. The system of claim 9, wherein the data tool further determines whether to validate the user based on comparing the received transaction and the stored user data.

11. The system of claim 10, wherein initiating the request to provide funds to the merchant further comprises determining the provided fund amount with the data tool.

12. The system of claim 1, wherein the one or more processors are further configured to add a fraudulent transaction indicator to the transaction data after receiving at least one of a notice from the user of a fraudulent transaction, a notice from the merchant of a fraudulent transaction, a notice from a financial service provider of a fraudulent transaction, and a notice from the fraud detection tool.

13. The system of claim 1, wherein the one or more processors are further configured to perform the operations comprising providing the user with real-time updates for the pending transaction.

14. The system of claim 1, wherein the one or more processors are further configured to perform the operations comprising, when the transaction data comprises at least one indicator:
receiving a response from the merchant for the questionnaire,
comparing the received user response and the received merchant response with the received transaction data or the stored user data,
determining whether to validate the user based on the comparison,
rejecting the pending transaction when the user is not validated, and
removing the indicator when the user is validated.

15. The system of claim 14, wherein the one or more processors are further configured to perform the operations comprising, when the transaction data comprises at least one indicator, receiving notice that the merchant disapproves the validation determination, and submitting the pending transaction for an additional review.

16. The system of claim 1, wherein the one or more processors are further configured to perform the operations comprising, when the transaction data comprises at least one indicator:
comparing the received response to the received transaction data or the stored user data, determining whether to validate the user based on the comparison,
receiving confirmation of the determination from a financial provider;
rejecting the pending transaction when the financial provider does not confirm the determination, and
removing the indicator when the financial provider confirms the determination.

17. The system of claim 1, wherein the one or more processors are further configured to perform the operations comprising reporting to a third party a subset of the stored received transaction data and the stored analysis.

18. The system of claim 1, wherein the indicator is a flag attached to the pending transaction.

19. A device for fraud dispute of pending transactions, comprising:
one or more memory devices storing instructions; and
one or more processors configured to execute the instructions to perform operations comprising:
receiving data corresponding to a pending transaction between the user and a merchant;
analyzing the transaction data to determine whether the transaction data comprises at least one indicator of a fraudulent transaction, wherein;
when the transaction data comprises at least one indicator:
pausing an initiation to provide funds for the pending transaction;
providing the user at least one questionnaire relating to the received transaction data or a set of stored user data,
receiving a response from the user for the questionnaire,
comparing the received response to the received transaction data or the stored user data,
determining whether to validate the user based on the comparison,
rejecting the pending transaction when the user is not validated, and
removing the indicator when the user is validated;
when the transaction data does not comprise at least one indicator:
approving the pending transaction, and PATENT
initiating a request to provide funds to the merchant; and
storing the received transaction data, and the analysis.

20. A method for fraud dispute of pending transactions, comprising:
receiving, at a storage medium, data corresponding to a pending transaction between the user and a merchant;
analyzing, with a processor, the transaction data to determine whether the transaction data comprises at least one indicator of a fraudulent transaction, wherein;
when the transaction data comprises at least one indicator:
pausing an initiation to provide funds for the pending transaction;
providing the user at least one questionnaire relating to the received transaction data or a set of stored user data,
receiving a response from the user for the questionnaire,
comparing the received response to the received transaction data or the stored user data,
determining whether to validate the user based on the comparison,
rejecting the pending transaction when the user is not validated, and
removing the indicator when the user is validated;
when the transaction data does not comprise at least one indicator:
approving the pending transaction, and initiating a request to provide funds to the merchant; and
storing, at a database, the received transaction data, and the analysis.
